(19) United States
(12) Patent Application Publication
(10) Pub. No.: US 2004/0071216 A1
(43) Pub. Date: Apr. 15, 2004

(54) Delivering video over an ATM/DSL network using a multi-layered video coding system

(76) Inventors: John William Richardson, Hamilton, NJ (US); Kumar Ramaswamy, Plainsboro, NJ (US); Thomas Anthony Stahl, Indianapolis, IN (US)

Correspondence Address: THOMSON MULTIMEDIA LICENSING INC, JOSEPH S TRIPOLI, PO BOX 5312, 2 INDEPENDENCE WAY, PRINCETON, NJ, 08543-5312, US

(21) Appl. No.: 09/745,215

(22) Filed: Dec. 21, 2000

(51) Int. Cl. G06K 9/36

(52) U.S. Cl. 375/240.21; 382/239; 725/95; 370/395.1

(57) ABSTRACT

A method of delivering video over a network includes separating the digitally compressed video signal into multiple sub-signals, coding each of the sub-signals, transmitting each of the sub-signals over asynchronous transfer mode (ATM) paths, receiving each of the sub-signals, and selecting certain said sub-signals according to a bandwidth suitable for subsequent reception over a digital subscriber line (DSL) path. Preferably, the step of combining selective ones of the sub-signals is based on a data rate capacity of the digital subscriber line (DSL) path for subsequent transmission. The bandwidth of the sub-signals selected is supported by the data rate of the digital subscriber line (DSL) path.

### FIELD OF THE INVENTION

The present invention generally relates to communications networks and, more particularly, to a multi-layered video coding system for delivering video over an ATM/DSL network.

### BACKGROUND OF THE INVENTION

Changing communications demands are transforming the existing public information network from one limited to voice, text and low resolution graphics to a powerful system capable of bringing multimedia, including full motion video, to everyone's home this century. A key communications transmission technology that is enabling transformation of existing public information networks to accommodate higher bandwidth needs is a modem technology known as Asymmetric Digital Subscriber Line. ADSL converts existing twisted-pair telephone lines into access paths for multimedia and high-speed data communications. ADSL can transmit up to 9 Mbps in the downstream direction to a subscriber and up to 1 Mbps upstream from the subscriber into the network. The rates of transmission are dependent on the distance of the subscriber from the Central Office (CO) Such rates expand existing access capacity by a factor of 50 or more without new cable installations.

Asynchronous transfer mode ATM is an ultra high-speed cell based data transmission protocol which may be run over ADSL. Digital subscriber line DSL technology is effected by modems on either end of a single twisted pair wire that delivers plain old telephone service POTS from a telephone central office to a customer's premises. A digital subscriber line access multiplexer DSLAM is a device which takes a number of ADSL subscriber lines and concentrates them to a single ATM line. Plain old telephone service POTS is basic analog telephone service that takes the lowest 4 kHz bandwidth on twisted pair wiring. Any service sharing a line with POTS must either use frequencies above POTS or convert POTS to digital and interleave with other data signals.

One of the limitations associated with ADSL is the bandwidth vs. distance problem. The closer the customer is to the service provider's Central Office (CO) the greater the available bandwidth. The further away the customer is the lower the available bandwidth. The following table indicates data rates supported by ADSL at increasing distance from the Central Office (CO). The first (and higher) number is the downstream rate while the second number is the upstream rate.

| Max | | | | | | | |
|---|---|---|---|---|---|---|---|
| distance (ft) | 1000 | 3000 | 4000 | 6000 | 10,000 | 12,000 | 18,000 |
| Asymmetric | 9 | 9 | 9 | 8.448 | 7 Mbps/ | 6.312 | 1.54 |
| DSL (ADSL) | Mbps/ | Mbps/ | Mbps/ | Mbps/ | 1 Mbps | Mbps/ | Mbps/ |
| | 1 Mbps | 1 Mbps | 1 Mbps | 1 Mbps | | 640 | 64 kbps |
| | | | | | | kbps | |

This bandwidth vs. distance relationship makes it challenging to offer video services to customers farther away from the Central Office. In an ADSL system that offers video as a service, not every customer is capable of obtaining video due to the different amounts of bandwidth available to them. In a case where the source of video material is only stored/encoded at one rate, not all customers will be able to subscribe to the service.

Accordingly, there is a need for enabling each customer the capability to subscribe to higher data bandwidth services, such as video, by obtaining a different quality or resolution of the data depending on the available bandwidth.

### SUMMARY OF THE INVENTION

A method of delivering video over a network comprising the steps of: separating the digitally compressed video signal into multiple sub-signals, coding each of the sub-signals, transmitting each of the sub-signals over asynchronous transfer mode (ATM) paths, receiving each of the sub-signals, and selecting certain ones of the sub-signals according to a bandwidth suitable for subsequent reception over a digital subscriber line (DSL) path.

Preferably, the step of selecting certain ones of the sub-signals is based on a data rate capacity of the digital subscriber line (DSL) path for subsequent reception. The bandwidth of the sub-signals selected is supported by the data rate of the digital subscriber line (DSL) path.

In another aspect, a network for delivering video over a digital subscriber line (DSL) path includes customer premises equipment (CPE) for coupling to a subscriber's communications device, a digital subscriber line access multiplexer (DSLAM) coupled over a digital subscriber line (DSL) path to the customer premises equipment, an asynchronous transfer mode (ATM) network coupled between the digital subscriber line access multiplexer (DSLAM) and a source of video signal, the video signal being made up of multiple video layers contributing to a resolution of the video signal when the multiple video layers are combined, and a network control for monitoring bandwidth available on the digital subscriber line (DSL) path to the customer premises equipment (CPE) and controlling the digital subscriber line access multiplexer (DSLAM) to deliver to the customer premises equipment (CPE) selective ones of the video layers.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is an exemplary system architecture for integrating voice, data, and video services and in which use of the invention is demonstrated.

FIG. 2 is a block diagram of an exemplary multi-layered video coding system.

FIG. 3 is a block diagram of an inventive multi-layered coding transport over an ATM/DSL network.

FIG. 4 is a block diagram exemplifying a customer receiving full resolution video over a 3000 ft. transmission distance and a transmission rate of 9 Mbps in accordance with the present invention.

FIG. 5 is a block diagram exemplifying a customer receiving medium resolution video over a 10,000 ft. transmission distance and a transmission rate of 7 Mbps.

FIG. 6 is a block diagram exemplifying a customer receiving lower resolution video over an 18,000 ft. transmission distance and a transmission rate of 1.544 Mbps.

It should be understood that the drawings are for purposes of illustrating the concepts of the invention and are not necessarily the only possible configuration for illustrating the invention. Like drawing elements are numbered the same throughout the different figures.

### DETAILED DESCRIPTION OF THE INVENTION

As noted above, the bandwidth vs. distance problem associated with DSL services makes it a challenge to offer video services to customers that are farther away from the Central Office. The invention solves this problem by enabling each customer the capability to subscribe to a video service by obtaining different quality or resolution video depending on their bandwidth. The problem is solved by using a layered video coding system, and then spreading the video layers across multiple ATM virtual circuits for distribution to the customer. Each customer can subscribe to or connect to a certain number of ATM virtual circuits depending on their available bandwidth.

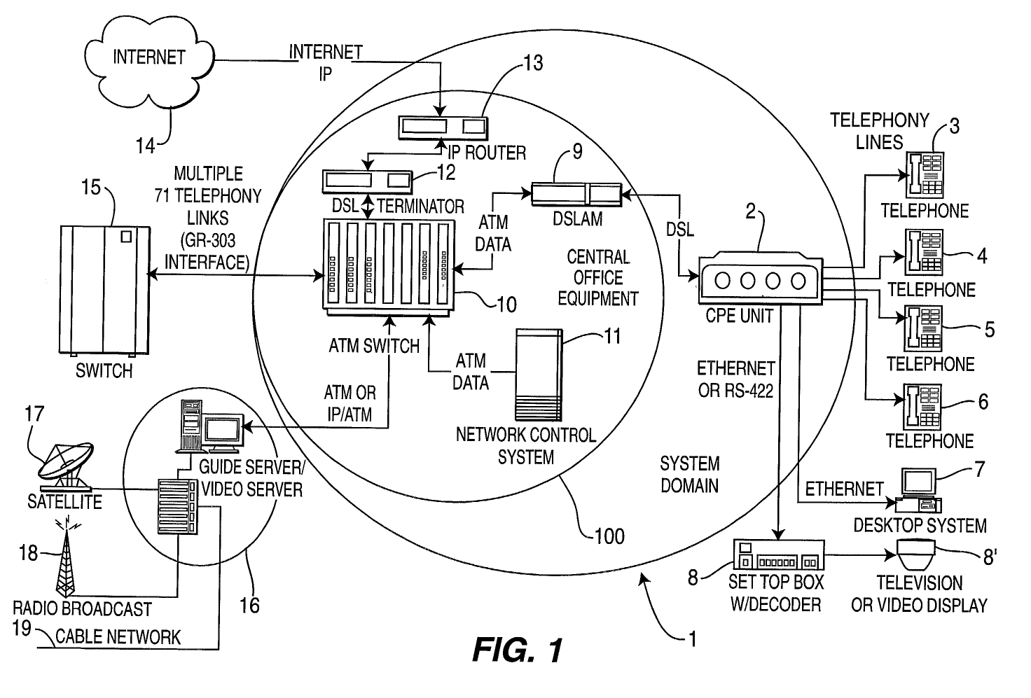

A DSL system architecture 1 for integrating voice, data and video services, shown in FIG. 1, is presented as an exemplary ATM/DSL network environment for employing the inventive method of enabling multi-layered broadcast video distribution. Details of the individual block components making up the system architecture are known to skilled artisans, and will only be described in details sufficient for an understanding of the invention. The system block diagram 1 is composed of several functional blocks. The system domain is composed of Central Office (CO) Equipment 100 and Customer Premise Equipment (CPE) 2. The component blocks within the system domain and their respective interfaces are: customer premise equipment (CPE), digital subscriber line access multiplexer (DSLAM) 9, an ATM switch 10, an IP router 13 and DSL terminator 12, and a network control system (NCS) 11.

The customer premise equipment (CPE) 2 includes a DSL modem unit that interfaces with the DSLAM over a plain old telephone service (POTS), four separate analog SLIC interfaces to connect to analog telephones 3-6, a 10Base-T Ethernet connection to a PC desktop system 7, and an Ethernet or RS-422 connection to a set-top box with a decoder 8 for connection to a television or video display 8′. From the customer's analog end, the CPE device 2 accepts the analog input from each of the telephones 3-6, converts the analog input to digital data, and packages the data into ATM packets (POTS over ATM), with each connection having a unique virtual channel identifier/virtual path identifier (VPI/PCI). Known to skilled artisans, ATM is a connection oriented protocol and as such there is a connection identifier in every cell header which explicitly associates a cell with a given virtual channel on a physical link. The connection identifier consists of two sub-fields, the virtual channel identifier (VCI) and the virtual path identifier (VPI). Together these identifiers are used at multiplexing, demultiplexing, and switching a cell through the network. VCIs and VPIs are not addresses, but are explicitly assigned at each segment link between ATM nodes of a connection when a connection is established, and remain for the duration of the connection. When using the VCINPI, the ATM layer can asynchronously interleave (multiplex) cells from multiple connections.

The Ethernet data is also encapsulated into ATM cells with a unique VPINCI. The ATM cell stream is sent to the DSL modem to be modulated and delivered to the DSLAM unit 9.

Going in the other direction, the DSL signal is received and demodulated by the DSL modem in the customer premise equipment 2 and delivered to VPINCI detection processing. The ATM cell data with VPINCI, matching that of the end user's telephone, is then extracted and converted to analog POTS to be delivered to the telephone. The ATM cell data, with VPINCI matching that of the end user's Ethernet, is extracted and delivered to an Ethernet transceiver for delivery to the port.

The digital subscriber line access multiplexer DSLAM 9 demodulates data from multiple DSL modems and concentrates the data onto the ATM backbone network for connection to the rest of the network. That DSLAM provides back-haul services for package, cell, and/or circuit based applications through concentration of the DSL lines onto ATM outputs to the ATM switch 10.

The ATM switch 10 is the backbone of the ATM network. The ATM switch 10 performs various functions in the network, including cell transport, multiplexing and concentration, traffic control and ATM-layer management. Of particular interest in the system domain 100, the ATM switch provides for the cell routing and buffering in connection to the DSLAM, network control system 11 and the Internet gateway (Internet Protocol IP router 13 and DSL terminator 12), and T1 circuit emulation support in connection with the multiple telephony links switch 15. A T1 circuit provides 24 voice channels packed into a 193 bit frame transmitted at 8000 frames per second. The total bit rate is 1.544 Mbps. The unframed version, or payload, consists of 192 bit frames for a total rate of 1.536 Mbps.

The ATM switch 10 is shown coupled to a program guide server/video server 16 to satellite 17, radio broadcast 18 or cable 19 networks. The ATM switch 10 is also coupled over the DSL terminator 12 and IP router 13 pair to receive Internet Protocol IP packet data from the Internet 14.

The network control system 100 provides for address translation, demand assignment and call management functions. The Network Control System's principle function is to manage the DSL/ATM networrk including the origination and termination of phone calls. The NCS is essential the control entity communication and translating control information between the class 5 PSTN switch (using the GR-303 protocol) and the CPE. The network control system 100 is available for other functions, such as downloadable code to the CPE and bandwidth and call management (e.g., busy) functions as well as other service provisioning and set up tasks. The NCS also sets up the connections within the CO equipment to route video from the video server to the various CPE connected to the DSLAM.

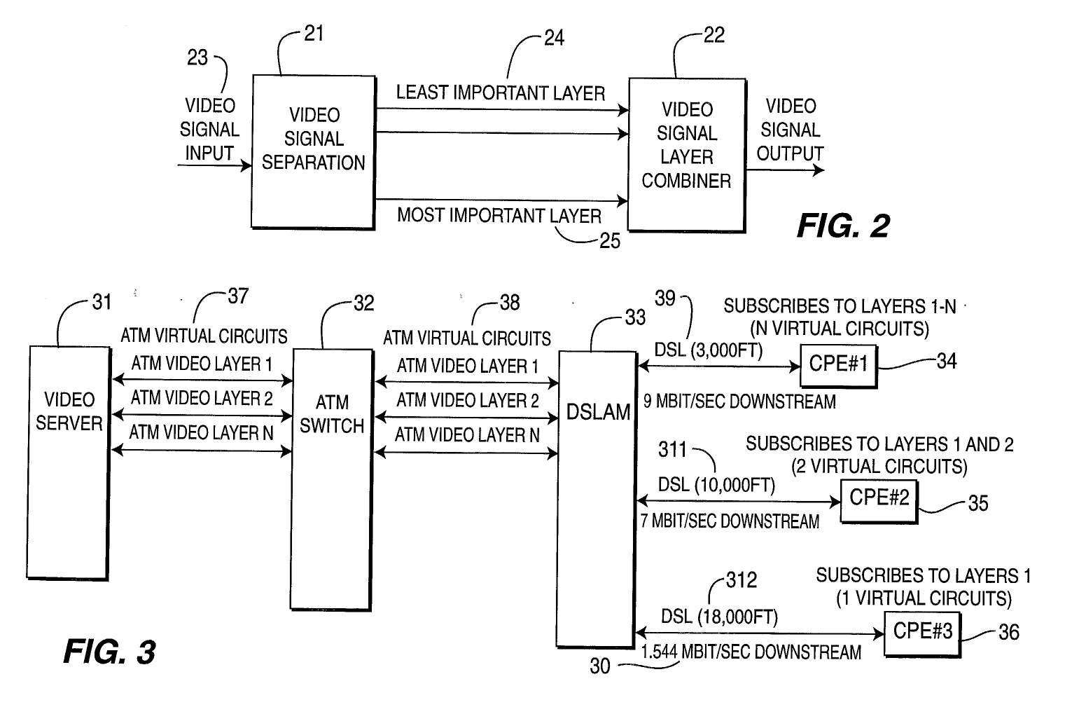

A basic multi-layered video coding system 20 is shown in FIG. 2. A video signal input 23 is received into a video signal separation 21 function block. The video signal separation 21 circuit functions to separate the video signal into multiple layers ranging from a least important layer 24 to a most important layer 25. The multiple layers 24 through 25 are received into a video signal layer combiner 22 function block and that combines the multiple layers to provide a video signal output.

The basic principle behind multi-layered coding is that the video signal is separated into sub-signals of various image detail that may be coded and transmitted independently of one another. Once these signals are received the sub-signals can be recombined to form the output signal. Layered coding typically offers a way of achieving error control by preventing the loss of perceptually important information. For example, in the event of network congestion, it is possible to discard the packets of less importance, i.e., where there is less perceptual information contained within these packets, without creating catastrophic effects in the video at the receiver. In multi-layered coding of video information, the first layer of coding generates the packets containing the most vital information required to reconstruct the most basic video at the receiver. The other additional layers generate enhancement packets that provide additional detail to the video.

Users of a DSL system that obtain different amounts of bandwidth depending on their distance from the service provider's Central Office can take advantage of a multi-layered video coding system for the delivery of video. This can be done by spanning the layers of the video coding across multiple ATM virtual circuits, as shown 30 in FIG. 3. The video server 31 separates the video signal into multiple ATM video layers 37 that are transmitted by an ATM switch 32 as multiple video layers 38 to a digital subscriber line access multiplexer DSLAM 33. The DSLAM 33 distributes the multiple video layers for transmission over distinct DSL paths 39, 311 and 312. As shown, portions of the multiple ATM video layer links 38 are transmitted to customer premises equipment 34 over a DSL path 3000 feet long at a data rate of 9 Mbps downstream. The DSLAM 33 transmits some of the ATM video layer paths 38 over a DSL path 10,000 feet 311 to a second customer premises equipment group 35. Lastly, the DSLAM 33 transmits the remaining portions of the multiple ATM video layer paths 38 over a DSL path 18,000 feet long 312 to a third customer premises equipment group 36.

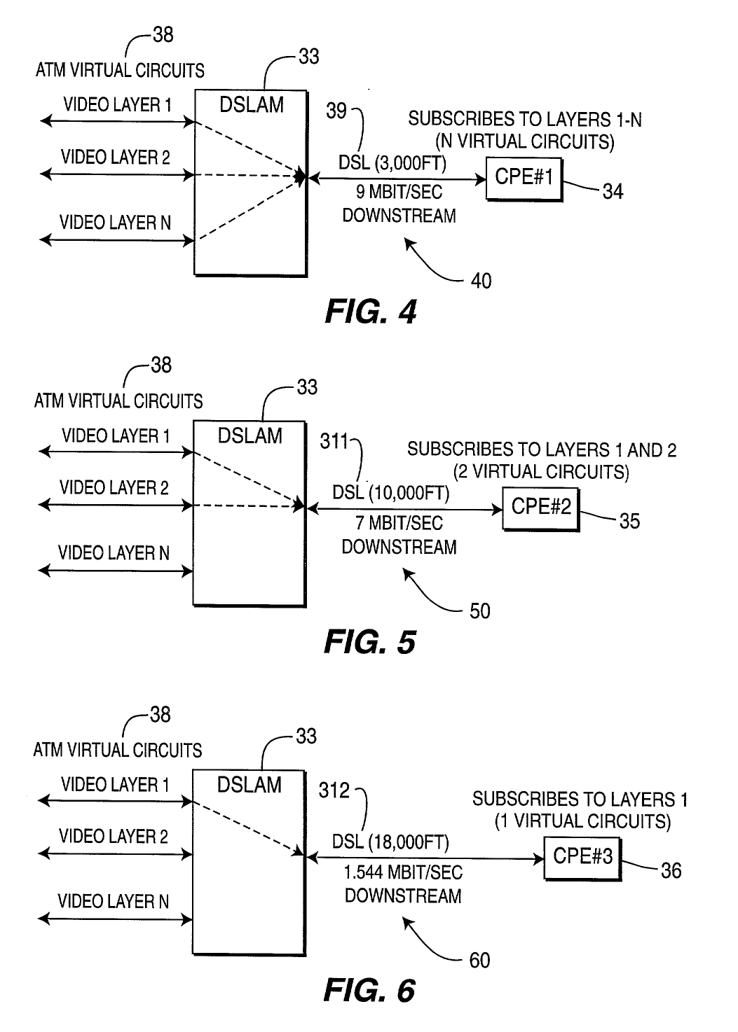

In the ATM/DSL network, each video layer occupies an independent ATM virtual circuit through the network. The customer premise equipment 34-36 will subscribe to a particular amount of video streams depending on the bandwidth available between the customer and the Central Office (CO). Each layer of video can occupy up to a specified amount of bandwidth. In the example of FIG. 3, each layer of video will occupy 1.5 Mbps. The customer that is within 3000 feet away is capable of obtaining 9 Mbps. Therefore, that customer can obtain the full resolution of video, obtaining each layer of video offered, by subscribing to all of the ATM virtual circuits offering the video content and/or program of interest. The customer that is 18,000 feet away is only capable of obtaining 1.5 Mbps. Therefore, that customer can only obtain one layer of video by subscribing to only one of the ATM virtual circuits. These examples are illustrated by the block diagrams of FIGS. 4-6. Video signal separation into multiple layers is done at the video server 16 and served up on multiple ATM virtual circuits. The video signal layer combiner is done at the customer DSL modem/customer premise equipment (CPE) 2 or the Set Top Box 8.

Distribution of the multiple video layers 38 across the DSL paths 39, 31 land 312 to the first, second and third customer premise equipment groups 34, 35 and 36 are detailed 40, 50 and 60 in FIGS. 4, 5 and 6, respectively. As can be seen by comparing FIGS. 4, 5 and 6, where the DSL path is shorter and the downstream data rate is higher, more video layers of the ATM virtual circuits can be combined by the DSLAM 33 unit. For example, over a DSL path of 3000 feet and a downstream data rate of 9 Mbps, 3 video layers are combined for downstream loading to the first customer premise equipment group 34. In comparison, for a DSL distance of 10,000 feet and with a downstream data rate of 7 Mbps, only 2 video layer signals are combined by the DSLAM unit 33 for downstream transport to the second customer premises equipment group 35. For a DSL data path of 18,000 feet long with a data rate of 1.544 Mbps, a single video layer is sent over the DSL path to a subscriber connected to the third customer premises equipment group 36. The examples of FIGS. 4, 5 and 6 demonstrate how subscribers further away from a video signal source over a DSL path can be accommodated by reducing the number of less critical video layers that would be downloaded to the subscriber over the DSL path. In this way, the longer DSL distance is accommodated by reduced resolution of video downloaded to the subscriber over the DSL path.

The network control system 100 in FIG. 1 has the ability to monitor the amount of bandwidth available on each of the individual DSL links through a communications path to the DSLAM. The DSLAM 9 will provide this data to the network control system 100. When a customer requires a channel of video, through either a channel change or through power-up, the network control system will identify the amount of bandwidth on the DSL link, between the DSLAM 9 and the customer premise equipment 2, and then connect the subscriber to the layers of video coding appropriate for the bandwidth of the DSL link. The video layers that the client is connected to are based upon the amount of bandwidth available. For example, if 9 Mbps is available, the network control system will connect the terminating customer device, such as the desktop system 7, to only one or two layers of the video coding, depending on what rate each of the video layers represents. The network control system adaptively connects the customer to the correct amount of video information and multiple layers (in the form of an ATM virtual circuit) over the DSL link based upon the amount of available bandwidth. Also, if for example a voice call needs to be made and not enough bandwidth is available to make the call, an enhancement or higher layer of the video can be dropped and then reconnected once the voice call has been completed.

Although the embodiment incorporating the teachings of the present invention has been shown and described in detail herein, those skilled in the art can readily devise many other varied embodiments that still incorporate these teachings.

We claim:

1. A method of delivering video over a network comprising the steps of:
separating the digitally compressed video signal into multiple sub-signals;
coding each of said sub-signals
transmitting each of said sub-signals over asynchronous transfer mode (ATM) paths;
receiving each of said sub-signals; and
selecting certain ones of said sub-signals according to a bandwidth suitable for subsequent reception over a digital subscriber line (DSL) path.

2. A method according to claim 1, wherein said step of selecting said sub-signals is based on a data rate capacity of the digital subscriber line (DSL) path for subsequent reception of said sub-signals.

3. A method according to claim 2, wherein the bandwidth of said sub-signals from said step of selecting is supported by the data rate of the digital subscriber line (DSL) path.

4. A method according to claim 1, wherein the number of said sub-signals from said step of selecting determines a video resolution of an output signal received by a subscriber.

5. A method according to claim 1, wherein said step of separating comprises said sub-signals being formed in terms of contributing to a desired resolution quality of the video signal.

6. A method according to claim 1, further comprising the step of transmitting said sub-signals from said step of selecting over a digital subscriber line (DSL) path to end-user equipment.

7. A method according to claim 1, wherein said step of separating the video signal is done by a video server.

8. A method according to claim 1, wherein the step of receiving each of the sub-signals is done by customer premises equipment (CPE).

9. A method according to claim 1, wherein the asynchronous transfer mode (ATM) paths are through an asynchronous transfer mode (ATM) network.

10. A method according to claim 1, wherein the step of separating comprises spanning the sub-signals across multiple asynchronous transfer mode (ATM) virtual circuits.

11. A method according to claim 1, wherein each of the sub-signals has a bandwidth smaller than that of the video signal.

12. A method according to claim 1, further comprising, after said step of coding, adding redundancy or error control coding on each of said sub-sub-signals, and, after said step of receiving, decoding said sub-signals using said redundancy or error control coding.

13. A network for delivering video over a digital subscriber line (DSL) path comprising:
customer premises equipment (CPE) for coupling to a subscriber's communications device;
a digital subscriber line access multiplexer (DSLAM) coupled over a digital subscriber line (DSL) path to the customer premises equipment;
an asynchronous transfer mode (ATM) network coupled between the digital subscriber line access multiplexer (DSLAM) and a source of video signal, the video signal being made up of multiple video layers contributing to a resolution of the video signal when the multiple video layers are combined; and
a network control for monitoring bandwidth available on the digital subscriber line (DSL) path to the customer premises equipment (CPE) and controlling the digital subscriber line access multiplexer (DSLAM) to deliver to the customer premises equipment (CPE) selective ones of the video layers.

14. The network according to claim 13, wherein the multiple video layers occupy multiple and independent asynchronous transfer mode (ATM) virtual circuits.

15. The network according to claim 13, wherein the subscriber's communications device includes at least one of a desktop system and a set-top box with decoder for coupling to a video display.

16. The network according to claim 13, wherein responsive to the network control the digital subscriber line access multiplexer (DSLAM) delivers the multiple video layers according to a preferred partial resolution of the video signal to be delivered to the customer premise equipment (CPE).

17. A network according to claim 13, wherein the bandwidth available on the digital subscriber line (DSL) path is determined by a wiring length from the digital subscriber line access multiplexer (DSLAM) to the customer premise equipment (CPE).

18. A network according to claim 13, wherein selective ones of the multiple video layers are delivered to said customer premises equipment to satisfy the available bandwidth according to how critical a particular one of the multiple video layers is to providing a desired partial resolution of the video signal at said customer premises equipment (CPE).

19. A network according to claim 13, wherein the digital subscriber line access multiplexer (DSLAM) can deliver more of the multiple video layers over the digital subscriber line (DSL) path as the DSL path decreases in length.
